(19) United States
(12) Patent Application Publication
(10) Pub. No.: US 2023/0383720 A1
(43) Pub. Date: Nov. 30, 2023

(54) WAVE ENERGY ABSORBER WITH ADJUSTABLE HYDRODYNAMIC PROPERTIES

(71) Applicant: MARINE POWER SYSTEMS LIMITED, Swansea (GB)

(72) Inventor: Graham FOSTER, Swansea (GB)

(73) Assignee: MARINE POWER SYSTEMS LIMITED, Swansea (GB)

(21) Appl. No.: 18/248,728

(22) PCT Filed: Nov. 3, 2021
(86) PCT No.: PCT/GB2021/052853

§ 371 Date: Apr. 12, 2023

(30) Foreign Application Priority Data
Nov. 4, 2020 (GB) 2017475.1

(51) Int. Cl. F03B 13/18; F03B 13/20

(52) U.S. Cl. CPC F03B 13/181; F03B 13/20; F05B 2270/1077; F05B 2260/406

(57) ABSTRACT

A buoyant wave energy capturing device is provided for use in a wave energy conversion (WEC) system, the device comprising: an absorber portion having a physical property linked to a hydrodynamic characteristic of the absorber portion; and wherein the physical property of the absorber portion, and in-turn, the hydrodynamic characteristic of the absorber portion, is arranged to be adjusted. The present invention aims to provide an improved energy capturing member for use in a WEC system which is less susceptible to damage as a result of large wave forces.

### FIELD OF THE INVENTION

The present invention relates to a wave energy capturing (WEC) system with a wave energy absorber that has adjustable hydrodynamic properties.

### BACKGROUND TO THE INVENTION

The world is transitioning to renewable energy—this transition will require the exploitation of all forms or renewable energy to provide the planet with energy it needs. One potential renewable energy source is wave power—an abundant and consistent energy resource available in all of the world's large oceans and seas. For this reason, means to improve the efficiency and cost effectiveness of wave power capture are needed.

Current wave harnessing devices are, however, limited in their capacity for capturing wave power continuously, particularly during fluctuating sea conditions. Suitable characteristics of a wave energy harnessing device often mean that such devices are optimised for harnessing wave energy within a specific window of suitable sea conditions. Such a narrow window of effectiveness often means that outside said window, such as during stormy sea conditions, the wave energy devices are susceptible to damage and failure unless forced into a reduced operational state.

It is therefore desirable to provide a wave energy harnessing device which is less susceptible to storm-related damage while maximising wave energy capture.

### SUMMARY OF THE INVENTION

The present invention is directed to a wave energy absorber positioned in a body of water in order to capture wave energy, the absorber being arranged to change a physical property thereof in order to increase or reduce hydrodynamic forces acting thereon as a result of wave motion. In relation to the present invention, the absorber is understood to be the part of the WEC system that moves in response to the waves and inputs energy to a power conversion part of the WEC system.

In particular the present invention is directed to a wave energy absorber arranged to change a physical property thereof in order to increase the hydrodynamic forces acting thereon during small wave conditions, and reduce the hydrodynamic forces acting thereon during large wave conditions such as during a storm. In doing so, the absorber is preferably arranged to remain functional during a wider variety of wave conditions.

Typical wave energy capturing absorbers may be designed to account for an optimal sea condition during which optimal wave energy capture is achieved. Any sea state which is smaller or larger than said optimal sea state can cause such wave energy capturing absorbers to suffer reduced functionality or even cause harm or excessive wear on any drive assembly system attached thereto. For this purpose, during larger sea states, wave energy absorbers can be retired to less functional, or non-functional position where the drive assembly system is protected. Such positions might, for example, be at an increased depth, or oriented such that a major face of the absorber is positioned parallel to wave direction, thereby providing reduced hydrodynamic load. In calm seas, and during these less functional, or non-functional positions, the wave energy capturing absorber is not able to make use of the wave energy available.

The present invention provides a wave energy absorber arranged to dynamically adjust a physical property thereof linked to a hydrodynamic characteristic of the absorber. Such adjustment therefore either increases or decreases the hydrodynamic nature of the absorber. Such an adjustment can be made in order to maximise the capture of energy during small waves, while also reducing the load on the absorber during large waves such that energy capture can still be made, without risking damage to any drive assembly affixed thereto.

Therefore, in accordance with an aspect of the present invention, there is provided a wave energy capturing device for use in a wave energy conversion (WEC) system, the device comprising: an absorber portion having a physical property linked to a hydrodynamic characteristic of the absorber portion; and wherein the physical property of the absorber portion, and in-turn, the hydrodynamic characteristic of the absorber portion, is arranged to be adjusted.

In preferable embodiments of the invention, the device comprises, or is affixed to a drive assembly of a WEC system by way of an attachment member. In preferable embodiments the device further comprises an adjustment mechanism arranged to perform said adjustment of the physical property of the absorber portion, and in-turn, the hydrodynamic property of the absorber portion. Therefore, any reference herein to any “adjustment” of the physical property, will be understood to, in some embodiments, be performable by an adjustment mechanism of the device. In the context of the present invention, the term “in-turn” will be understood to refer to a consequential adjustment of the hydrodynamic characteristic as a direct result of said adjustment of the physical property. The term “a physical property” will be understood to be used to refer to “one or more” said physical properties, each said physical property being linked to a corresponding hydrodynamic characteristic, wherein two or more said physical properties may be linked to a common corresponding hydrodynamic characteristic.

The term “hydrodynamic characteristic” will be appreciated by the skilled addressee as any characteristic acting as a measure of, or determinant of, the hydrodynamics of the absorber portion. Typical hydrodynamic characteristics of interest in WEC design could, for example, include (but are not limited to): response amplitude operators (RAOs) in, for example, heave, surge, pitch, sway and roll or any components thereof; an added mass; a drag (such as, for example, a drag coefficient); a radiation force; a diffraction force. Other suitable hydrodynamic characteristics will be appreciated.

The term “physical property” will be appreciated by the skilled addressee as any physical property of the absorber portion having a relationship with the hydrodynamic characteristic. In preferable embodiments, the physical property is one selected from the range: size; volume; shape; geometry; porosity; transparency; surface area; mass; weight; buoyancy. Other suitable physical properties will be appreciated. The terms “porosity” and “transparency” will be understood as being intended to convey an availability of pathways through the absorber portion, along which fluid may travel unhindered. An increase in porosity or transparency may therefore constitute a reduced overall capacity of the device to resist or occlude flow of water, and therefore alter the hydrodynamic response of the absorber portion. Any adjustment of porosity or transparency may therefore involve any occlusion, or alternatively unobstruction, of said pathways (or a portion thereof) through the absorber portion. Such pathways may take any form and may result from apertures in the absorber portion.

In some embodiments, the adjustment (which may be by an adjustment mechanism) is arranged to adjust at least one dimension of the absorber portion. Preferably the absorber portion comprises a major axis which may optionally be oriented perpendicular to a wave direction, wherein the at least one dimension is a length of the absorber portion along the major axis. In preferable embodiments, the adjustment may be arranged to increase or reduce said length of the absorber portion. For example, the absorber portion may comprise an expandable section arranged to be expanded in one or more directions by way of the adjustment. In some examples, the absorber portion may comprise a central section and a peripheral section, wherein the peripheral section is arranged to be accommodated within at least a portion of the central section or positioned about at least a portion of the central section. In such embodiments, the peripheral section may be arranged to move as a result of the adjustment (for example by an adjustment mechanism), such that the peripheral section extends from the central section. Thereby, the adjustment is preferably arranged to extend the length of the absorber portion by way of the peripheral section, which in turn provides a greater surface area and/or volume for the absorber portion to interact with the waves. The greater surface area/volume in-turn increases the magnitude of the hydrodynamic forces generated by the absorber portion, thereby allowing the wave energy capturing device to capture more wave energy.

In some embodiments, the absorber portion may comprise an outer shell or skin having one or more apertures located therein, wherein one or more of said apertures may comprise a corresponding occlusion member arranged to occlude said aperture. Two or more of said apertures may share a common occlusion member. In some embodiments, the adjustment is arranged to move the occlusion member between a first position in which the occlusion member substantially occludes the corresponding aperture; and a second position in which the occlusion member does not occlude the corresponding aperture. In preferable embodiments, said apertures provide a fluid pathway from one side of the device to an opposing side of the device such that fluid may pass from one aperture to an opposing aperture when said apertures are unobstructed by the occlusion member in the second position. Thereby, when the occlusion members are in the second position, the absorber portion preferably comprises a greater porosity and/or transparency, such that the absorber portion's hydrodynamic interaction with the waves is reduced, permitting reduced wave energy capture by the device. Conversely, in the first position, the porosity of the absorber portion is preferably reduced, thereby increasing the absorber portion's hydrodynamic interaction with the waves, and permitting more wave energy capture by the device.

In some embodiments, the absorber portion may comprise one or more inflatable portions, wherein the adjustment is arranged to inflate and deflate the inflatable portions. The one or more inflatable portions may be accommodated within the absorber portion, or positioned on a surface thereof. As such the inflatable portions may serve to increase different physical properties of the absorber portion such that wave forces acting on the absorber portion are affected accordingly. In some embodiments, the inflatable portions may be used, when inflated, to increase a size, volume or surface area of the absorber portion, providing a greater surface against which wave forces may act. The inflatable portions may, in some embodiments, adjust the shape of the absorber portion such that a different (for example, more, or less) hydrodynamic shape is achieved once the inflatable portions are inflated, and affecting the wave forces acting against the absorber portion accordingly. In some embodiments, the inflatable portions may be used, when inflated, to occlude apertures in the absorber portion, thereby decreasing the porosity of the absorber portion and increasing the surface against which wave forces may act.

In embodiments wherein the absorber portion comprises one or more apertures, the one or more occlusion members may comprise the one or more inflatable portions; wherein at the first position, the one or more inflatable members are inflated by way of the adjustment such that said inflatable members occlude the corresponding aperture; and wherein at the second position, the one or more inflatable members are deflated by way of the adjustment such that said inflatable members do not occlude the corresponding aperture. In such embodiments the one or more inflatable portions are accommodated within the absorber portion.

The inflatable portions, in some embodiments, preferably extend from the absorber portion, along a major axis thereof. Other embodiments will be appreciated wherein the inflatable portions may be positioned at any suitable position adjacent to the absorber portion.

In preferable embodiments, an adjustment mechanism of the device may be arranged to receive power from a WEC system (such as a buoyant offshore renewable energy system) to perform the adjustment of the physical property. The power is preferably sourced at least in part from wave energy converted by the system, the converted wave energy having been captured by the wave energy capturing device. The wave energy capturing device may therefore contribute energy toward an energy conversion system within the WEC system, wherein said energy may be used to power the adjustment mechanism of the device.

In accordance with a second aspect of the present invention, there is provided a wave energy conversion (WEC) system arranged to convert wave energy into useful energy, the system comprising: a platform; and a drive assembly mounted on the platform and arranged to capture and convert wave energy, the drive assembly comprising a wave energy capturing device in accordance with the first aspect.

In preferable embodiments, the system is a buoyant offshore renewable energy system having a buoyant platform supporting said drive assembly.

The wave energy capturing device may be positioned at a height relative to an upper surface of the platform. In some embodiments, the drive assembly may be arranged to adjust the height between an in-use height and a docked height, the in-use height being greater than the docked height (i.e. the in-use height is closer to the surface of the body of water and the docked height is deeper in the water). In some such embodiments, the in-use height is a height at which the wave energy capturing device may capture wave energy, whereas at the docked height the wave energy capturing device may not capture wave energy. Such a docked height may be used in some embodiments during a transport and maintenance configuration or during a storm survival configuration.

In preferable embodiments, the adjustment of the height by the drive assembly may be independent of a working stroke of said drive assembly. Therefore in such embodiments, the drive assembly may continue to function in capturing and converting wave energy to useful energy, while the height adjustment takes place, such that said height adjustment does not reduce the capacity of the drive assembly to function.

In preferable embodiments, the system comprises an in-use configuration in which the platform and the wave energy capturing device of the drive assembly are submerged in a body of water, and wherein the wave energy capturing device is positioned at the in-use height. At the in-use configuration, the absorber portion of the wave energy capturing device may be arranged to interact with the waves such that the absorber portion moves in the body of water, thereby driving the drive assembly. The absorber portion preferably tracks an orbital movement path in-use. In preferable embodiments, at the in-use height, the physical property of the absorber portion is adjusted by way of the adjustment to maximise hydrodynamic forces on the absorber portion.

Embodiments will be appreciated wherein, during fluctuating sea states, the physical property of the absorber portion may be dynamically adjusted by way of the adjustment according to said fluctuating sea states. For example, if a sea state during a first period constitutes a small sea state, the physical property may be adjusted by way of the adjustment in order to optimise the hydrodynamic response of the absorber portion, such that maximal wave forces are permitted to act on the absorber portion, thereby maximising capture of the available wave energy during the small sea state. If the sea state changes during a second period to a larger sea state, the adjustment may adjust the physical property of the absorber portion such that, at the in-use height, a reduced amount of wave energy is able to act on the absorber portion. The reduced amount of wave energy may comprise a sufficient wave force for the device to operate in capturing wave energy, but not exceeding a safe wave force threshold over which damage or excessive wear may be inflicted upon the device, or an energy conversion system affixed thereto.

In some preferable embodiments, the system comprises a storm configuration in which the platform and the wave energy capturing device of the drive assembly are submerged in a body of water, and wherein the physical property of the absorber portion is adjusted by way of the adjustment to minimise hydrodynamic forces on the absorber portion.

In some preferable embodiments, the adjustment of the physical property of the absorber portion is arranged to occur when the wave energy capturing device is positioned at, or approaches, the docked height. The platform or a docking mechanism or cradle supported thereon arranged to receive the absorber portion preferably comprises an adjustment mechanism arranged to actuate at or on approach of the absorber portion to the docked height, in order to adjust the physical property. Said adjustment preferably reduces the response of the absorber portion to the wave energy.

In some embodiments, the system comprises an energy storage device arranged to receive and store energy converted by the drive assembly, and wherein the adjustment mechanism is arranged to receive and use said stored energy to perform said adjustment. The adjustment mechanism may therefore be powered by stored energy captured by the device, and may not require any other external power source.

It will be appreciated that features described herein as being suitable for incorporation into one or more aspects and embodiments of the present invention are intended to be generalizable across any and all aspect and embodiments of the present disclosure.

### DETAILED DESCRIPTION

Embodiments of the present invention will now be described by way of example only and with reference to the accompanying drawings, in which:

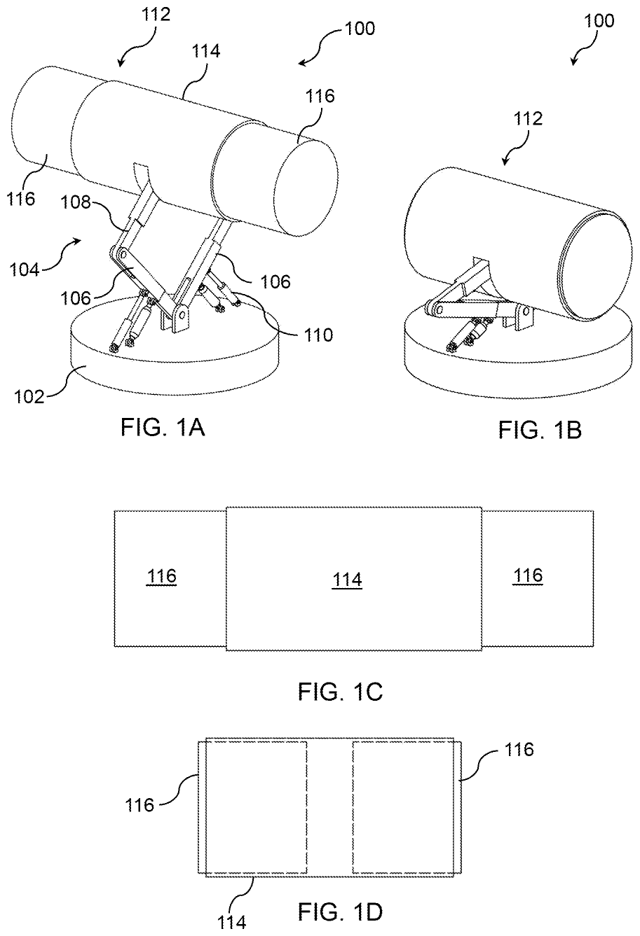

FIG. 1A shows a perspective view of an example WEC system in accordance with the second aspect comprising an example wave energy capturing device in accordance with the first aspect positioned at an in-use height;

FIG. 1B shows a perspective view of the example embodiment of FIG. 1A, the wave energy capturing device positioned at a docked height;

FIG. 1C shows a plan view of the wave energy capturing device shown in FIG. 1A;

FIG. 1D shows a plan cutaway view of the wave energy capturing device shown in FIG. 1B;

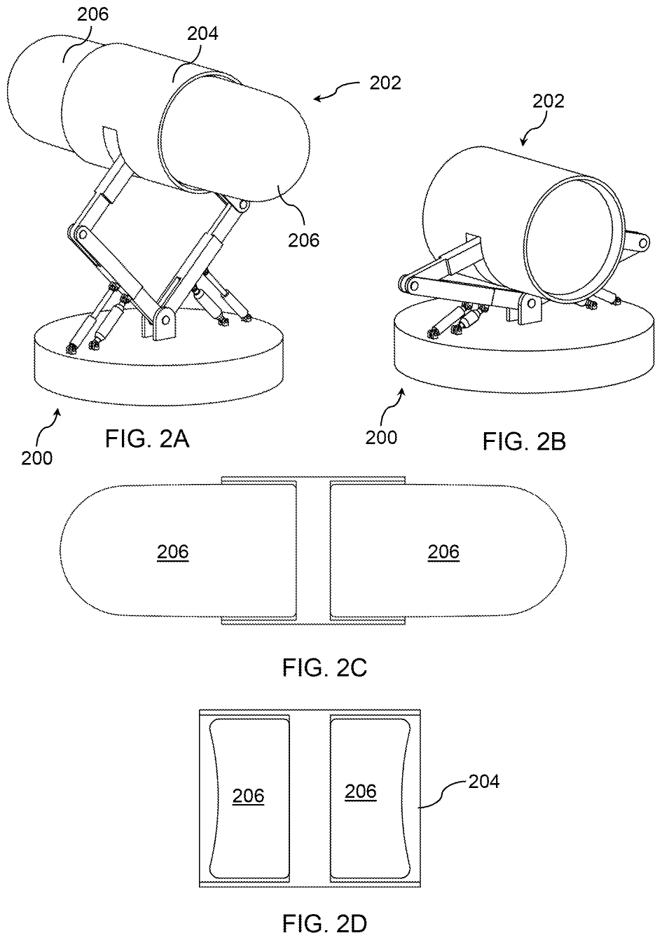

FIG. 2A shows a perspective view of a further example WEC system in accordance with the second aspect comprising an example wave energy capturing device in accordance with the first aspect positioned at an in-use height;

FIG. 2B shows a perspective view of the example embodiment of FIG. 2A, the wave energy capturing device positioned at a docked height;

FIG. 2C shows a plan cutaway view of the wave energy capturing device shown in FIG. 2A;

FIG. 2D shows a plan cutaway view of the wave energy capturing device shown in FIG. 2B;

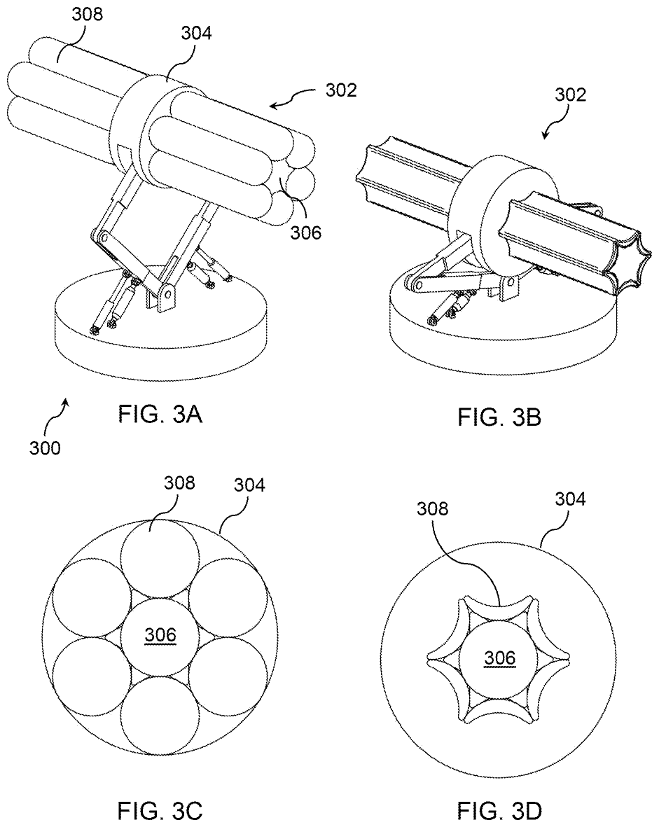

FIG. 3A shows a perspective view of a further example WEC system in accordance with the second aspect comprising an example wave energy capturing device in accordance with the first aspect positioned at an in-use height;

FIG. 3B shows a perspective view of the example embodiment of FIG. 3A, the wave energy capturing device positioned at a docked height;

FIG. 3C shows a lateral view of the wave energy capturing device shown in FIG. 3A;

FIG. 3D shows a lateral view of the wave energy capturing device shown in FIG. 3B;

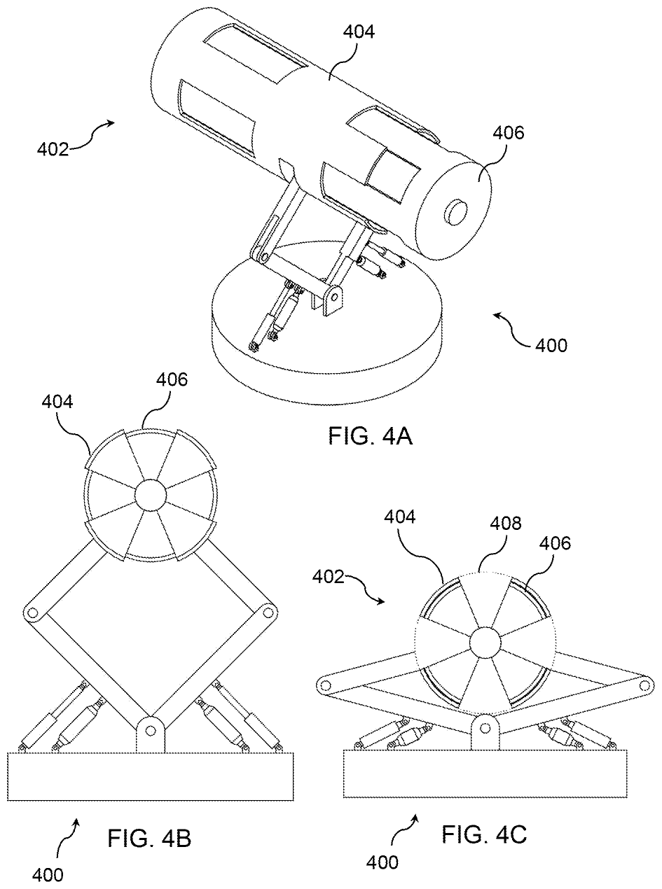

FIG. 4A shows a perspective view of a further example WEC system in accordance with the second aspect comprising an example wave energy capturing device in accordance with the first aspect positioned at an in-use height;

FIG. 4B shows a lateral view of the embodiment shown in FIG. 4A;

FIG. 4C shows a lateral view of the embodiment shown in FIG. 4A, wherein the wave energy capturing device is positioned at a docked height;

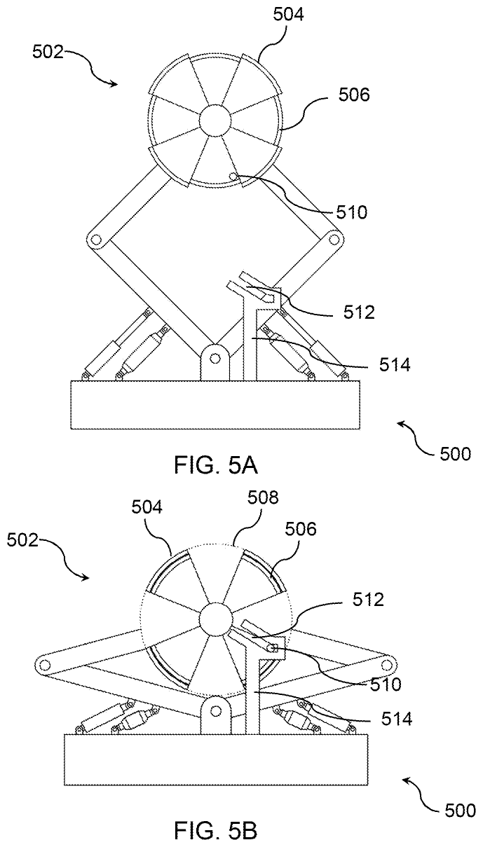

FIG. 5A shows a lateral view a further embodiment similar to that shown in FIG. 4A, the adjustment mechanism arranged to be actuated as the wave energy capturing device approaches a docked height;

FIG. 5B shows a lateral view of the embodiment of FIG. 5A, the wave energy capturing device positioned at a docked height;

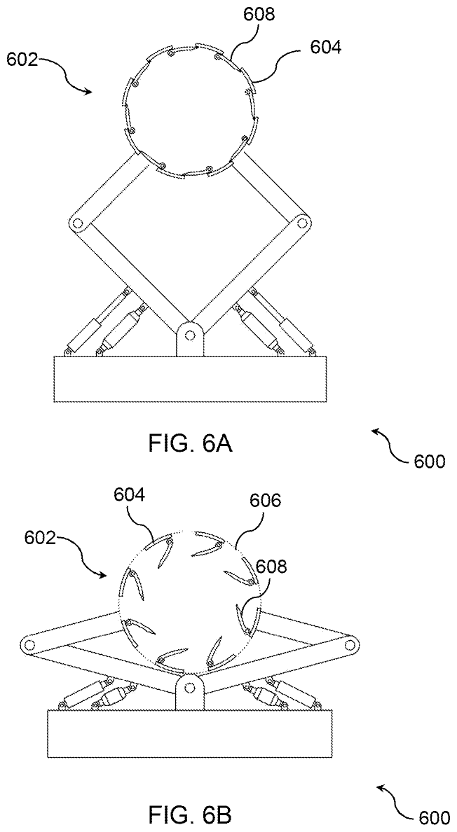

FIG. 6A shows a lateral view of a further example WEC system in accordance with the second aspect comprising an example wave energy capturing device in accordance with the first aspect positioned at an in-use height;

FIG. 6B shows a lateral view of the embodiment of FIG. 6A, the wave energy capturing device positioned at a docked height;

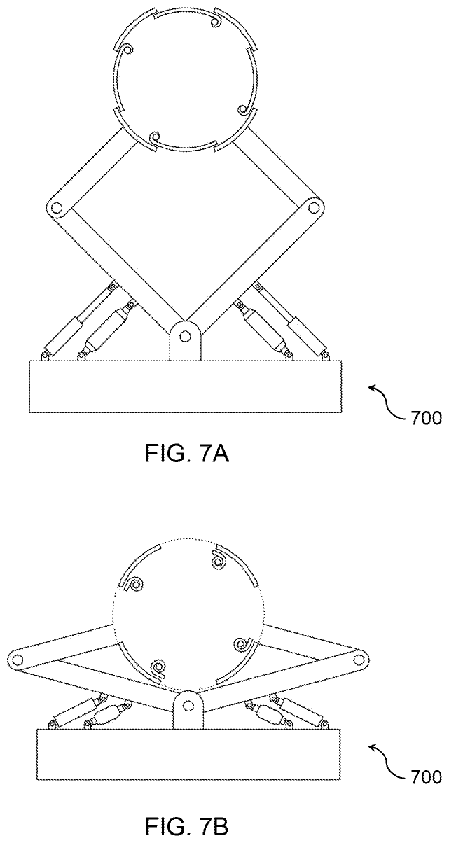

FIG. 7A shows a lateral view of a further example WEC system in accordance with the second aspect comprising an example wave energy capturing device in accordance with the first aspect positioned at an in-use height;

FIG. 7B shows a lateral view of the embodiment of FIG. 7A, the wave energy capturing device positioned at a docked height;

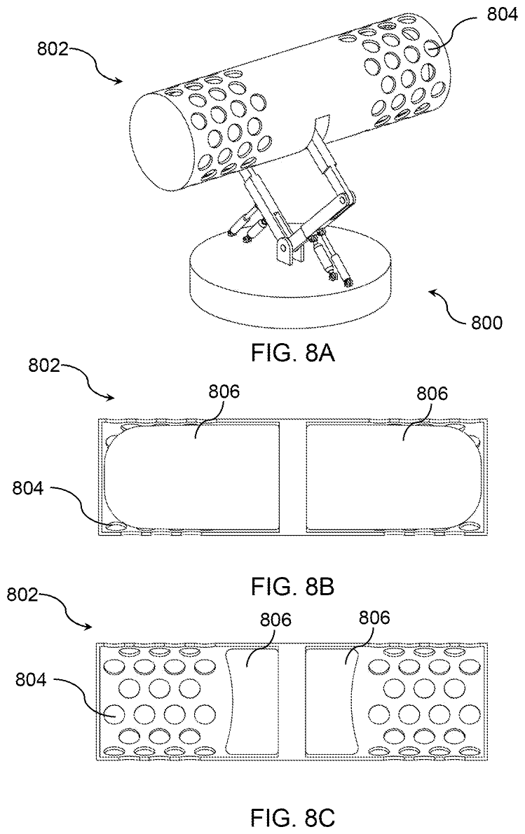

FIG. 8A shows a perspective view of a further example WEC system in accordance with the second aspect comprising an example wave energy capturing device in accordance with the first aspect positioned at an in-use height;

FIG. 8B shows a plan cutaway view of the wave energy capturing device shown in FIG. 8A, comprising an occluding member at a first position; and

FIG. 8C shows the embodiment of FIG. 8B, the occluding member at a second position.

All of the presently described embodiments comprise a wave energy capturing device in accordance with the first aspect as part of a WEC system in accordance with the second aspect. The embodiments each have substantially the same general structure which is summarised briefly here. The system comprises a platform supporting a drive assembly on an upper surface thereof.

The platform does not form part of the disclosed invention and is illustrative of the need for a substantially fixed position for the drive assembly. For a wave energy converting device of this type to be effective the wave energy absorber must move relative to a platform with the differential motion between the two being exploited by the drive assembly to generate power. The platform could be a structure that is fixed to the seabed or it could be a floating structure that is anchored to the seabed via mooring lines (such as that disclosed in WO2019002864 and EP2776707).

The drive assembly described in the preferred embodiments is exemplary only and illustrates one possible way in which the functions of the second aspect of the invention can be realised in practice. The drive assembly comprises a first lower pair of opposing elongate rigid lever arms coupled at one end at a lower hinge positioned centrally on the upper surface of the platform. The other end of each lever arm of the first lower pair is rotatably affixed to one end of a corresponding rigid lever arm of a second upper pair of lever arms. The second upper pair of lever arms are coupled at an upper hinge. The drive assembly further comprises a wave energy absorber in accordance with the first aspect, affixed to the upper hinge. Each lever arm of the first lower pair of lever arms is affixed to an energy converter, which for illustrative purposes takes the form of hydraulic ram and a hydraulic spring, but may comprise any suitable energy converter such as a linear or rotational electrical generator coupled to a physical spring member.

Other drive assembly layouts are possible that permit the function of the first and second aspects of the invention, such as that described in WO2019030534.

In use, the platform and the wave energy absorber as described in the illustrated embodiments are submerged in a body of water and using a mooring and anchoring system (not shown). In the in-use configuration, the absorber is arranged to move following a substantially orbital trajectory as a result of the subsurface orbital wave forces impacting thereon. As the wave energy capturing device moves, the consequential movement of the lever arms drives the corresponding energy converters.

However, the invention is not limited to WEC devices that are wholly submerged as shown, or to those requiring a mooring and anchoring system. The invention is equally applicable to WEC devices having an absorber which is floating on the surface of the body of water, such as in EP2321526.

The extent of the ability of the wave energy capturing device to capture wave energy is generally proportional to the availability of wave forces acting on the absorber portion of the device. During small sea states wherein available wave forces are relatively low, it is advantageous to maximise the hydrodynamic response of the device to the waves. Thereby, efficient and effective use of the minimal available wave energy can be made in order to capture and covert the wave energy associated therewith. Conversely, during larger sea states, the availability of wave energy may be too high, with the potential to damage the drive assembly through high forces transferred from the absorber. It is therefore advantageous to reduce the hydrodynamic response of the device, such that less of the prevailing wave energy is captured by the absorber and transferred to the rest of the machine.

One method of reducing the hydrodynamic response to the waves involves further submerging the wave energy absorber to a greater depth (and reduced height relative to the platform), away from the higher wave motions acting closer to the surface of the body of water. In some instances, however, such a repositioning of the device may not achieve sufficient reduction in wave forces acting thereon. It may therefore be beneficial to further reduce the hydrodynamic response of the device by way of the present invention. The present invention may also be used at the in-use depth of the wave energy device, such that dynamic reduction or increase in hydrodynamic response may be achieved in order to maximise wave energy capture while minimising potential risk of damage to a system.

Referring to FIG. 1A to FIG. 1D, a first embodiment 100 of the present invention is shown, and functions substantially as previously described. The embodiment 100 comprises a wave energy converting (WEC) system 100 in accordance with the second aspect comprising a buoyant platform 102 supporting a drive assembly 104 mounted on an upper surface thereof. The drive assembly comprises a first lower pair of rigid lever arms 106 and a second upper pair of rigid lever arms 108 as previously described. The drive assembly 104 comprises energy converters 110 affixed to both the lower pair of lever arms 106 and the platform 102. Coupled to the second pair of lever arms 108, the wave energy converting device 100 further comprises a cylindrical wave energy absorber 112. In the embodiment 100 shown, the absorber 112 comprises a cylindrical absorber portion having a central section 114 arranged to accommodate a pair of cylindrical peripheral sections 116. The absorber 112 further comprises an adjustment mechanism (not shown). In an in use configuration as shown in FIG. 1A, the adjustment mechanism is arranged to move the peripheral sections 116 of the absorber portion such that the protrude outwardly from opposing ends of the central section 114, thereby extending the length of the absorber 112. In the in-use configuration shown, the extended length of the absorber 112 maximises hydrodynamic response and therefore wave forces acting on the absorber 112, such that energy capture is maximised. Referring to FIG. 1B, a storm survival configuration is shown in which the wave energy absorber 112 is retracted by the lever arms 106, 108 of the drive assembly 104 to a docked height. The adjustment mechanism retracts the peripheral sections 116 of the absorber 112 into the central section 114, such that the length of the absorber 112 is reduced. In the docked configurations shown, the reduced length of the absorber 112 minimises hydrodynamic interaction with the waves, and therefore forces acting on the absorber 112, for safety. The respective configurations of the absorber 112 described for FIG. 1A and FIG. 1B are depicted for clarity in FIG. 1C and FIG. 1D respectively.

The embodiment 200 shown in FIG. 2A to FIG. 2D works substantially the same as described for FIG. 1A to FIG. 1D. The wave energy absorber 202 of FIG. 2A to FIG. 2D comprises a cylindrical central section 204 and opposing inflatable peripheral sections 206. The device 202 further comprises an adjustment mechanism (not shown) talking the form of an water pump (which in the example embodiment shown is an electrical water pump) arranged to pump water into the inflatable peripheral sections 206 as shown in FIG. 2A and FIG. 2C. The pump is further arranged to pump water out of the inflatable sections 206 such that the sections 206 deflate. The sections 206, in the example embodiment shown, have elastomeric properties to allow a return to a smaller deflated configuration as shown in FIG. 2B and FIG. 2D. Alternative embodiments will be appreciated wherein the sections 206 may be arranged to perform any other suitable alternating, reciprocating or biasing action between an inflated and deflated state, such as being arranged to fold or crumple to allow the smaller deflated configuration. In the embodiment 200 shown, the central section 204 of the absorber 202 achieves sufficient buoyancy for the wave energy converting device 200 to function in the in use configuration whether the peripheral sections 206 are inflated or deflated. Embodiments will, however, be appreciated wherein the inflatable portions 206 may be inflated using air to achieve additional buoyancy of the absorber during use. A reduced buoyancy of the absorber portion when deflated, or inflation using water, may achieve greater safety in a storm survival configuration described herein.

The embodiment 300 shown in FIG. 3A to FIG. 3D works substantially the same as described for FIG. 1A to FIG. 1D. The wave energy absorber 302 of FIG. 3A to FIG. 3D comprises a cylindrical central section 304 and a pair of opposing rods 306 extending therefrom, each rod 306 supporting a plurality of inflatable members 308 thereon. The device 302 further comprises an adjustment mechanism (not shown) talking the form of a water pump (which in the example shown is an electrical water pump) arranged to pump water into the inflatable members 308 as shown in FIG. 3A and FIG. 3C. The pump is further arranged to pump water out of the inflatable members 308 such that the inflatable members 308 deflate. The elastomeric properties of the inflatable members 308 result in a return to a smaller deflated configuration as shown in FIG. 3B and FIG. 3D when deflated. As with the embodiment 200 of FIG. 2A to FIG. 2D, the pump may alternatively pump any fluid, including air. Any other suitable inflation mechanism will be envisaged such as that described herein.

With reference to FIG. 4A to 4C, a further embodiment 400 is shown which captures and converts wave energy in substantially the same way as the embodiments described for FIG. 1A to FIG. 3D, but which makes use of a different physical property of the absorber 402 linked to a hydrodynamic characteristic of the absorber 402. The embodiment 400 comprises a substantially cylindrical wave energy capturing device 402 having a first outer portion 404 and a second inner portion 406 nested partially within the outer portion 404. Each of the inner portion 406 and the outer portion 404 comprise rectangular apertures 408 equally distributed about the respective circumferences of each of the inner portion 406 and the outer portion 404. In the embodiment 400 shown, the wave energy capturing device 402 further comprises an adjustment mechanism (not shown) taking the form of an electrical motor arranged to rotate the inner portion 406 relative to the outer portion 404. The motor is arranged to rotate the inner portion 406 between a first closed position, as shown in FIG. 4B, and a second open position, as shown in FIG. 4C.

In the first position of FIG. 4B, the rectangular apertures 408 of the inner portion 406 do not align with rectangular apertures 408 of the outer portion 404, and the apertures 408 of the outer portion 404 are therefore occluded by the walls of the inner portion 406. A solid absorber 402 of the wave energy capturing member 402 is therefore provided such that no fluid pathways are provided through the absorber 402. As such wave forces acting on the absorber 402 in the first closed position of FIG. 4B are maximised.

In the second open position of FIG. 4C, the rectangular apertures 408 of the inner portion 406 align directly with the rectangular apertures 408 of the outer portion 404, and the apertures 408 of the outer portion 404 are therefore unobstructed, such that fluid pathway through the wave energy absorber 402 is provided between approximately opposing apertures 408. Therefore, in the open position of FIG. 4C, wave forces acting on the wave energy absorber 402 are minimised. While FIG. 4B shows the wave energy absorber 402 in the closed position and positioned at an in-use height, the wave energy capturing device 402 may be placed in the open position at the in-use height when higher wave forces are available for energy capture. While only a fully-closed and a fully-open position are shown, the embodiment 400 shown may assume any intermediary position therebetween through adjustment by the adjustment mechanism. While in the embodiment 400 shown, the adjustment mechanism is arranged to rotate the inner portion 406 relative to the outer portion 404 which remains stationary, embodiments will be appreciated wherein the adjustment mechanism may rotate either or both of the inner portion 406 and the outer portion 404. In the embodiment 400 shown, the substantially complete circumference of the closed configuration of FIG. 4B does not have to be completely watertight to function well as a wave energy absorber—it may simply need to prevent water from flowing freely through the absorber 402. The incomplete circumference of the open configuration of FIG. 4C needs to be sufficiently incomplete to allow water to pass freely through the absorber 402. The minimum transparency of the absorber 402 may, for example, be approximately 50%, which has been shown to be sufficient to allow water to pass freely through it. While an electrical motor is described for the adjustment mechanism, any suitable mechanical actuator can be used to achieve the rotational movement, for example a rotary motor (either electrical or hydraulic) or a linear actuator acting on a crank.

The embodiment 500 shown in FIGS. 5A and 5B is substantially the same as that described for FIG. 4A to 4C, having a wave energy absorber 502 with an outer portion 504 and an inner portion 506 rotatable relative thereto, each having equally distributed rectangular apertures 508. In the embodiment 500 shown, however, the adjustment mechanism takes the form of a pin and track system comprising a protruding pin 510 extending outwardly from a wall region of the inner portion 506, and an angular track 512 supported above the surface of the platform on a stand 514, the track 512 being positioned on the platform to engage the pin 510 as the wave energy absorber 502 moves from the in-use height shown in FIG. 5A and approaches the docked height shown in FIG. 5B. The track 512 is sized to engage the pin 510, which subsequently follows the track 512 as the wave energy absorber 502 is lowered to the docked height. As the absorber 502 is lowered, the pin 510 moves in a trajectory defined partly by a direction perpendicular to the direction of movement of the absorber 502. The movement of the pin 510 causes the inner portion 506 to rotate such that the absorber 502 assumes an open configuration wherein the apertures 508 of the inner portion 506 align with those of the outer portion 504 and fluid pathways are defined through the absorber 502 between approximately opposing apertures 508. Therefore, in the docked position shown in FIG. 5B, which may for example be a storm survival configuration, the absorber 502 is in an open position to minimise wave forces acting on the absorber 502. In the embodiment 500 shown, the absorber 502 further comprises a biasing member (not shown) taking for the form of a spring, the spring urging the inner portion 506 toward the closed configuration shown in FIG. 5A when the pin 510 is not engaged with the track 512. Embodiments will be appreciated wherein any suitable adjustment mechanism is provided. The static pin and track adjustment mechanism of the embodiment 500 shown ensures that no power is required to operate the mechanism, which may be beneficial to optimise power usage. Other adjustment mechanisms will be appreciated which achieve the same effect, such as a lever on the outer cylinder that pushes against the platform as it approaches the docked height causing the outer or inner cylinder to rotate when the absorber is docked.

With reference to FIGS. 6A and 6B, a further embodiment 600 is shown functioning substantially as discussed previously. In the embodiment 600 shown, the wave energy absorber 602 comprises a cylindrical absorber having an outer skin 604 having a plurality of apertures 606 positioned thereon. The absorber further comprises a plurality of hinged flaps 608 located on an interior surface of the absorber, the hinged flaps 608 each arranged to rotate about a respective hinge to occlude a respective aperture 606 of the absorber. The absorber 602 further comprises an adjustment mechanism (not shown) taking the form of an electrical motor arranged to rotate the flaps 608 about the hinge between a first closed position wherein the flaps 608 occlude the apertures 606 as shown in FIG. 6A and a second open position wherein the flaps 608 do not occlude the apertures 606 as shown in FIG. 6B. Embodiments will be appreciated wherein the flaps can be individually actuated with an actuator (not shown) such as a rotary motor or a linear actuator and crank. Alternatively, all of the flaps can be connected to a single actuator ring (not shown) that opens/closes all the flaps simultaneously. The flaps may, of course, be partially opened or closed in order to achieve a graded adjustment to the porosity and/or transparency such that the corresponding hydrodynamic characteristic is adjusted in the same graded fashion.

The embodiment 700 of FIG. 7A and FIG. 7B is substantially the same as that described for FIG. 6A and FIG. 6B, but wherein the flaps comprise a flexible material, such as fabric, and are each wound around a respective rotor. The embodiment 700 further comprises an adjustment mechanism (not shown) comprising an electric motor arranged to rotate each of the rotors such that the fabric flaps affixed thereto may be wound about the rotor to reveal the apertures of the absorber, or unfurled to occlude the apertures. In the closed position shown in FIG. 7A, the flaps are maximally unfurled to occlude the apertures of the absorber, such that the porosity and/or transparency of the absorber is reduced and wave forces acting on the absorber are maximised. In the open position shown in FIG. 7B, the flaps are maximally wound about the rotors such that the apertures are unobstructed, providing fluid pathways through the absorber such that wave forces acting on the absorber are minimised.

Referring now to FIG. 8A to 8C, a further embodiment 800 is shown, the embodiment 800 arranged to capture and convert wave energy in a substantially equal way to the other embodiments described herein. The embodiment 800 comprises a wave energy absorber 802 comprising a cylindrical absorber having a hollow shell with a plurality of apertures 804 positioned therein. The absorber further comprises a pair of opposing inflatable members 806 accommodated within the shell and arranged to be inflated or deflated within the shell by an adjustment mechanism (not shown). The adjustment mechanism in the embodiment 800 shown is a water pump arranged to inflate or deflate the inflatable members 806 with water. The pump is arranged to achieve a closed position as shown in FIG. 8B wherein the inflatable members 806 are inflated with water such that an elastomeric skin of the inflatable members 806 expands to occlude the apertures 804 of the absorber. The pump is further arranged to achieve an open position as shown in FIG. 8C wherein the inflatable members are deflated, wherein the elastomeric material of the inflatable members 806 returns to a deflated state and does not occlude the apertures of the absorber. Embodiments will be appreciated wherein the pump may pump either water or air as described herein, and other embodiments will be appreciated having any other suitable adjustment mechanism. Embodiments will be appreciated wherein the absorber is any suitable shape, and comprises holes of any suitable number and shape. The holes can be any size provided they are not so large that the inflatable members, which may take the form of an inflatable bladder, become unsupported. Embodiments will be appreciated comprising any suitable number of inflatable members, and may comprise only a single inflatable member.

Further embodiments within the scope of the present invention may be envisaged that have not been described above, for example, the buoyant platform is illustrated as a fixed block in all of the described embodiments for illustration purposes only, but embodiments will be appreciated wherein the platform is any suitable structure arranged to remain relatively stationary in the body of water relative to the energy absorber. For example, the platform may comprise a buoyant underwater platform that is moored to the seabed; any buoyant/non-buoyant structure that directly affixes to, or does not affix to, the seabed.

The energy converter in all described embodiments, for illustrative purposes only, is shown to be a simplified hydraulic cylinder combined with a separate spring unit. Embodiments will be appreciated wherein in any suitable form of energy converter may be used, for example: a linear electrical generator; a rotational electrical or hydraulic generator; or any kind of rotational generator which may be combined with a mechanism that converts rotational motion to linear motion such as a rack and pinion.

The adjustment mechanisms described take the form of a motor driving a hydraulic cylinder. Any suitable adjustment mechanism, including any suitable mechanical mechanism, will be appreciated, such as any hydraulic mechanism or a rack and pinion gear.

The absorbers of the described embodiments take the same general cylindrical shape, but embodiments will be appreciated wherein any shape of absorber, or any section thereof, may be used.

The invention is not limited to the specific examples or structures illustrated and will be understood to be any embodiment falling within the scope of the appended claims.

1. A wave energy capturing device for use in a wave energy conversion (WEC) system, the device comprising:
an absorber portion for absorbing wave energy, the absorber portion having a physical property linked to a hydrodynamic characteristic of the absorber portion; and
wherein the physical property of the absorber portion, and in-turn, the hydrodynamic characteristic of the absorber portion, is arranged to be adjusted.

2. A device as claimed in claim 1, wherein the hydrodynamic characteristic is one or more selected from the group: a response amplitude operator associated with heave, surge, pitch, sway, roll, and/or a component thereof of the absorber portion; a drag coefficient, and/or a component thereof, of the absorber portion.

3. A device as claimed in claim 1, wherein the physical property is one selected from the range: size; volume; shape; geometry; porosity; transparency; surface area; mass; weight; buoyancy.

4. A device as claimed in claim 1, wherein the adjusted physical property is at least one major dimension of the absorber portion.

5. A device as claimed in claim 4, wherein the absorber portion comprises a major axis oriented perpendicular to a wave direction, wherein the at least one dimension is a length of the absorber portion along the major axis.

6. A device as claimed in claim 1, wherein the absorber portion is formed of a skin having one or more apertures located thereon, one or more of said apertures comprising a corresponding occlusion member arranged to occlude said aperture.

7. A device as claimed in claim 6, wherein the occlusion member is arranged to move between a first position in which the occlusion member substantially occludes the corresponding aperture; and a second position in which the occlusion member does not occlude the corresponding aperture.

8. A device as claimed in claim 1, wherein the absorber portion comprises one or more inflatable portions, wherein the one or more inflatable portions are arranged to be inflated and/or deflated, wherein said inflation and/or deflation of said inflatable portions changes the physical property of the absorber portion.

9. A device as claimed in claim 8, wherein the inflatable portions extend along a major axis of the absorber portion.

10. A device as claimed in claim 8, when dependent on claim 7, wherein the one or more occlusion members comprise the one or more inflatable portions;
wherein at the first position, the one or more inflatable members are inflated such that said inflatable members occlude the corresponding aperture; and
wherein at the second position, the one or more inflatable members are deflated such that said inflatable members do not occlude the corresponding aperture.

11. A wave energy conversion (WEC) system arranged to convert wave energy into useful energy, the system comprising:
a platform; and
a drive assembly mounted on the platform and arranged to capture and convert wave energy, the drive assembly comprising a wave energy capturing device as claimed in any one of the preceding claims.

12. A system as claimed in claim 11, wherein the wave energy capturing device is positioned at a height relative to an upper surface of the platform and wherein the drive assembly is arranged to adjust the height between an in-use height and a docked height, the in-use height being greater than the docked height.

13. A system as claimed in claim 12, wherein the adjustment of the height by the drive assembly is independent of one or more of: the adjustment of the physical property of the absorber portion of the wave energy capturing device; a working stroke of said drive assembly.

14. A system as claimed in claim 12, wherein the system comprises an in-use configuration in which the platform and the wave energy capturing device of the drive assembly are submerged in a body of water, and wherein the wave energy capturing device is positioned at the in-use height.

15. A system as claimed in claim 14, wherein at the in-use height, the physical property of the absorber portion is adjusted to maximise hydrodynamic forces on the absorber portion.

16. A system as claimed in claim 12, wherein the system comprises a storm configuration in which the platform and the wave energy capturing device of the drive assembly are submerged in a body of water, and
wherein the physical property of the absorber portion is adjusted to minimize hydrodynamic forces on the absorber portion.

17. A system as claimed in claim 16, wherein the adjustment is arranged to occur automatically when the wave energy capturing device is positioned at, or approaches, the docked height.
